(19) United States
(12) Patent Application Publication
(10) Pub. No.: US 2013/0015280 A1
(43) Pub. Date: Jan. 17, 2013

(54) ROLLER CUTTER FOR SHREDDER, AND SHREDDER

(71) Applicants: Tetsuro Tamaki, Osaka (JP); Seiichi Koike, Osaka (JP); Shinji Nakamura, Osaka (JP); Toru Yoshii, Osaka (JP)

(72) Inventors: Tetsuro Tamaki, Osaka (JP); Seiichi Koike, Osaka (JP); Shinji Nakamura, Osaka (JP); Toru Yoshii, Osaka (JP)

(73) Assignee: KOKUYO CO., LTD., Osaka-shi, Osaka (JP)

(21) Appl. No.: 13/638,665

(22) PCT Filed: Mar. 24, 2011
(86) PCT No.: PCT/JP2011/057101

§ 371 Date: Oct. 1, 2012

(30) Foreign Application Priority Data
Apr. 6, 2010 (JP) 2010-087901
Mar. 16, 2011 (JP) 2011-057661

(51) Int. Cl. B02C 18/18; B02C 18/06

(52) U.S. Cl. 241/236; 241/294; 241/295

(57) ABSTRACT

Provided is a roller cutter for a shredder having sufficient strength obtained by using a reduced amount of a metallic material. A roller cutter for a shredder is provided with a rotary shaft rotationally driven by a drive mechanism, finely cutting blades each including disks joined together on inside surfaces thereof, the finely cutting blades being successively mounted on and supported by the rotary shaft with the angular phase of each of the blades displaced by a predetermined angle from each other, and shaft fixation members which are fixed to the rotary shaft to thereby fix the finely cutting blades to the rotary shaft under conditions where the members have been mounted at both ends of the finely cutting blades. In this roller cutter, the finely cutting blades have folded parts forming thick-walled portions which go into contact with each other, the folded parts being formed by folding inward the sheet metal material used for forming the disks.

### RELATED APPLICATION

The present application relates to and claims the benefit of priority to Patent Application No. PCT/JP2011/057101 filed Mar. 24, 2011, which is hereby incorporated by reference in its entirety for all purposes as if fully set forth herein.

### TECHNICAL FIELD

The present invention relates to a shredder capable of shredding sheets of paper, or the like, and to a roller cutter for a shredder that is used in the shredder.

### BACKGROUND ART

A shredder incorporates a finely cutting mechanism having roller cutters which can shred objects to be shredded, such as sheets of paper, credit cards, compact discs (CDs) or digital versatile discs (DVDs). Generally speaking, a widely known structure of this finely cutting mechanism is such that a pair of roller cutters are arranged parallel to each other with one of the roller cutters overlapping the other in part. When using the shredder, an object to be shredded is inserted in between the pair of roller cutters and the roller cutters facing each other are rotated in directions in which the object to be shredded is pulled into the shredder. By doing so, the object to be shredded is shredded between the pair of roller cutters. Such shredders are classified into a straight type in which the object to be shredded is shredded only in a direction in which the object is inserted, whereby strip-shaped shreds are discharged, and a so-called cross type in which the object to be shredded is cut also in a direction intersecting the direction in which the object is inserted while being shredded in to strip-shaped shreds, whereby relatively short shreds are discharged as described in Patent Documents 1 and 2.

Each of these roller cutters has a plurality of finely cutting blades made of a sheet metal material that are arranged at specific intervals along an axial direction in such a manner that the finely cutting blades of one roller cutter overlap those of the other roller cutter as viewed along the axial direction and no gaps are formed between the finely cutting blades of the two roller cutters in plan view. Specifically, the width of each shred formed is determined by the thickness of a portion of each finely cutting blade that cuts the object to be shredded.

Should this be the case, it would be necessary to increase the thickness of the sheet metal material used for the finely cutting blades when setting the finely cutting blades to have a large width, and this would result in an increase in the amount of use of the sheet metal material. Also, as it is necessary to manufacture the finely cutting blades by machining the thick sheet metal material, a greater work load will be required for the machining compared to a case where a thin sheet metal material is used. Under such circumstances, the use of the thick sheet metal material will also result in an increase in manufacturing cost of roller cutters.

On the other hand, there is also a structure in which each of the finely cutting blades is configured with a pair of disks formed by bending a sheet metal material so as to increase the outside thickness of the pair of disks as described in Patent Document 2. This approach of simply bending the sheet metal material, however, does not provide a sufficient strength at bending points depending on the thickness of the sheet metal material, and this may lead to a possibility that neither sufficient strength of the finely cutting blades nor sufficient durability thereof that is affected by the strength is attained.

In particular, most of conventional finely cutting blades have generally been configured to be fitted on a rotary shaft having a polygonal cross section so as to be fixed thereto. To manufacture the rotary shaft having the polygonal cross section, however, it is needed to machine the surface of a rod member with high precision. This has resulted in a problem that a conventional shredder manufacturing process would inevitably require an increased amount of work.

### PRIOR ART DOCUMENTS

### Patent Documents

Patent Document 1: Registered Japanese Utility Model No. 3122126.
Patent Document 2: Registered Japanese Utility Model No. 3129584

### SUMMARY OF THE INVENTION

### Technical Problems

It is an object of the present invention to provide roller cutters for a shredder having sufficient strength using a reduced amount of a metallic material as well as a shredder provided with the relevant roller cutters.

### Solution to Problem

To accomplish the aforementioned object, the present invention provides the below-described means. Specifically, a roller cutter for a shredder according to the present invention comprises a plurality of finely cutting blades arranged along an axial direction, each of the finely cutting blades being configured with at least a pair of disks which are assembled together, wherein each of the finely cutting blades has at least on one of the disks a thick-walled portion which is formed by inwardly increasing the thickness of a piece of a sheet metal material constituting the disk and goes into contact with the other disk.

Here, the expression “thick-walled portion” is a concept including various forms of arrangements, such as an arrangement in which a thick-walled portion is formed by attaching a separate piece of a sheet metal material by welding, for instance, and an arrangement in which a thick-walled portion is formed by simply increasing the thickness of the sheet metal material in part, in addition to an arrangement in which the thick-walled portion is formed by folding a piece of a sheet metal material.

Also, a shredder according to the present invention comprises at least a pair of roller cutters structured as described above, the pair of roller cutters being located to partially overlap each other.

Here, the expression “each of the finely cutting blades being configured with at least a pair of disks which are assembled together” does not mean that each of the finely cutting blades is configured only in a state in which the disks are paired, but expresses a concept in which one of the disks constitutes part of the finely cutting blade even if one of the paired disks is positioned at an end under conditions where the one of the paired disks adjoins another one of the paired disks.

The above-described structure makes it possible to increase the thickness of the finely cutting blade by as much as the thickness of the sheet metal material increased at the thick-walled portion. Since the sheet metal material remains at an original thickness thereof at locations other than the thick-walled portion, it is possible to reduce the amount of the metallic material needed compared to a conventional structure in which dimensions of the finely cutting blade are determined only by the thickness of the sheet metal material. Also, as the sheet metal material is structured solid at the thick-walled portion, the structure provides sufficient strength in a thickness direction as well. Therefore, it becomes possible to impart sufficient strength and resultant durability to each finely cutting blade even if thin pieces of the sheet metal material are used.

While most of shredders are of a so-called cross type in which each finely cutting blade is provided with projecting parts capable of shredding an object to be shredded, it is desirable to form projecting parts by using thick-walled portions which project from an outer periphery of the disk in radial directions perpendicular to the axial direction. This structure makes it possible to preferably perform cross-cutting operation with the projecting parts having sufficient strength which is obtained by folding the sheet metal material.

A specific structure for preferably forming the projecting part by using the thick-walled portion is such that the projecting part is formed by folding part of the sheet metal material projecting from the outer periphery of the disk and, subsequently, a shredding edge capable of shredding an object to be shredded along a rotating direction of the finely cutting blade is formed.

A structure capable of preferably performing the cross-cutting operation is such that the projecting part has a first shredding edge for cutting the object to be shredded along a direction in which the object is inserted and a second shredding edge for cutting the object to be shredded along a direction intersecting the inserting direction of the object to be shredded.

Shreds of the object to be shredded cut by the finely cutting blade are greatly affected by the shape of the shredding edge. If the first shredding edge is configured to have a curved portion which extends outward from the outer periphery in a continuously curved shape, it is possible to effectively avoid formation of permanent bends in the shreds and effectively prevent a problem that the shreds become undesirably bulky within the shredder or become jammed or entangled in another location of the shredder.

Then, to effectively prevent a problem that the object to be shredded becomes bitten between the disks when the second shredding edge shreds the object to be shredded, it is preferable to structure the second shredding edge to have a swelling end which sticks out while swelling outward from the inside of the disk in such a manner that a gap between basal parts where the second shredding edges extend from a joint between the two disks is made narrow.

While conventional roller cutters are often structured to include a separate member placed between one finely cutting blade and another, it is possible to effectively reduce the number of components if each of the finely cutting blades is structured to have a spacer portion which protrudes outward and goes into contact with the adjacent one of the finely cutting blades.

In positioning finely cutting blades on a conventional roller cutter in the rotating direction, on the other hand, the finely cutting blades have been positioned by engaging individually independent finely cutting blades with a shaft having a polygonal cross section so as not to suddenly rotate mainly with respect to the shaft. In contrast, it is possible to effectively eliminate a process of machining a shaft to have a large surface area for engaging the finely cutting blades with the shaft in the shredder of the present invention if each finely cutting blade is structured to include an engagement part which projects outward and can determine relative positions along the rotating direction around an axis with respect to the adjacent finely cutting blade.

Another structure which can realize high-precision positioning even when a strong force acts on the engagement part while the finely cutting blades rotate is such that the engagement part of one of the paired disks projects outward while the engagement part of the other of the paired disks projects inward, and an end of each of the engagement parts constitutes a tight contact surface which can go into tight contact with an end of the engagement part of the adjacent finely cutting blade along the projecting direction thereof.

In particular, a specific structure of this engagement part is such that the engagement part projects further outward from a swell end of the aforementioned spacer portion.

By using the aforementioned spacer portion, it is possible to preferably position the finely cutting blades if each of the finely cutting blades is structured to have a shaft hole in which a rotary shaft is fitted so that a cylindrical rotary shaft for supporting the plurality of finely cutting blades can be implemented.

A specific structure for preferably fixing the individual finely cutting blades using an arrangement for positioning the finely cutting blades by means of the engagement part is such that the roller cutter further comprises shaft fixation members for fixing the finely cutting blades located at both ends along the axial direction for fixing the finely cutting blades to the rotary shaft under conditions where relative positions of the plurality of finely cutting blades have been determined.

Also, in order to assemble the disks constituting each of the finely cutting blades easily and securely, it is preferable that each of the finely cutting blades have a fitting part for fitting together the paired disks by a recess/protrusion fitting structure.

### Advantageous Effects of Invention

According to the present invention, it is possible to reduce the amount of metallic material needed as the sheet metal material. It becomes also possible to impart sufficient strength and resultant durability to each finely cutting blade even if thin pieces of the sheet metal material are used.

### BRIEF DESCRIPTION OF THE DRAWINGS

FIG. 1 is an external view of a shredder according to one embodiment of the present invention;

FIG. 2 is an external view of roller cutters according to the embodiment;

FIG. 3 is a diagram for explaining the structure of the roller cutters;

FIG. 4 is an external view of a principal portion according to the embodiment;

FIG. 5 is a plan view of the principal portion;

FIG. 6 is a diagram for explaining the structure of the principal portion;

FIG. 7 is a left side view of the principal portion;

FIG. 8 is a right side view of the same;

FIG. 9 is another left side view of the principal portion;

FIG. 10 is a right side view of the same;

FIG. 11 is an enlarged view representing another principal portion of the embodiment;

FIG. 12 is the same as above;

FIG. 13 is a diagram for explaining an operational feature according to the embodiment;

FIG. 14 is another diagram for explaining the operational feature according to the embodiment;

FIG. 15 is the same as above;

FIG. 16 is the same as above;

FIG. 17 is the same as above;

FIG. 18 is a diagram for explaining a variation of the embodiment;

FIG. 19 is a diagram for explaining the structure of a principal portion according to a second embodiment of the present invention;

FIG. 20 is a left side view of the above principal portion;

FIG. 21 is a right side view of the same;

FIG. 22 is another left side view of the above principal portion;

FIG. 23 is a right side view of the same;

FIG. 24 is an enlarged view representing another principal portion of the embodiment;

FIG. 25 is a diagram for explaining an operational feature according to the embodiment;

FIG. 26 is another diagram for explaining the operational feature according to the embodiment.

### DESCRIPTION OF EMBODIMENTS

A first embodiment of the present invention is described hereunder with reference to the drawings.

A shredder S according to this embodiment is intended for use at home or in a so-called small office/home office (SOHO) that will be preferably used in a small-sized office, such as at home or in a SOHO sector, having a capacity to accommodate 2 to 3 liters of shreds, for example.

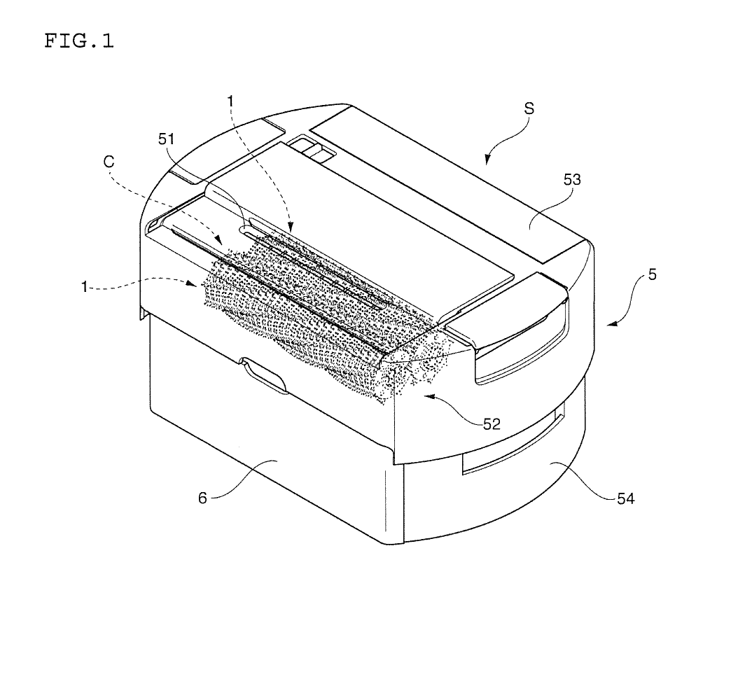

As illustrated in FIG. 1, the shredder S mainly includes a single housing 5, a finely cutting mechanism C provided inside the housing 5 that is depicted by broken lines in the Figure for finely cutting an object to be shredded like paper, and a drawer-shaped waste bin 6 accommodating shreds and discharging the same to the exterior of the housing 5. While the shredder S of the present embodiment is also provided with a drive mechanism for driving the finely cutting mechanism C, an operating portion including a mains power switch for operating the finely cutting mechanism C, an interlock mechanism for preventing finely cutting blades 3 from operating under conditions where the waste bin is not inserted, for example, various kinds of conventional arrangements can be employed for these mechanisms and elements. Therefore, a detailed description of these mechanisms and elements is not provided here.

As depicted in FIG. 1, the housing 5 has a feed opening 51 formed in an upper surface of the housing 5 for feeding the object to be shredded, a mechanism accommodating portion 52 provided beneath the feed opening 51 for accommodating the finely cutting mechanism C for shredding the object to be shredded and the drive mechanism for driving the finely cutting mechanism C, a cord accommodating portion 53 for accommodating a power cord, and a waste bin accommodating portion 54 for holding the drawer-shaped waste bin 6 for accommodating shreds in such a manner that the waste bin 6 can be inserted and removed.

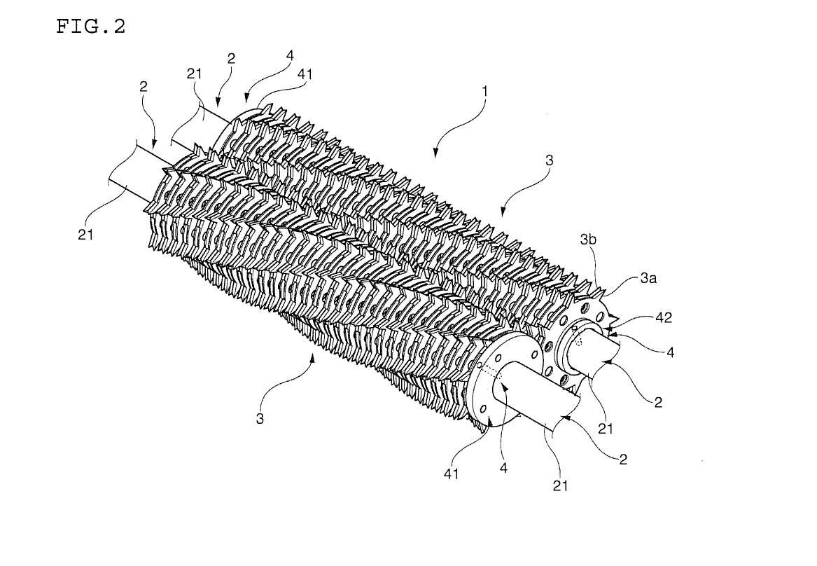

As depicted in FIGS. 1 and 2, the finely cutting mechanism C includes a pair of roller cutters 1 according to the present invention which is disposed on opposite sides of a position corresponding to the feed opening 51 with the two roller cutters 1 partially overlapping each other.

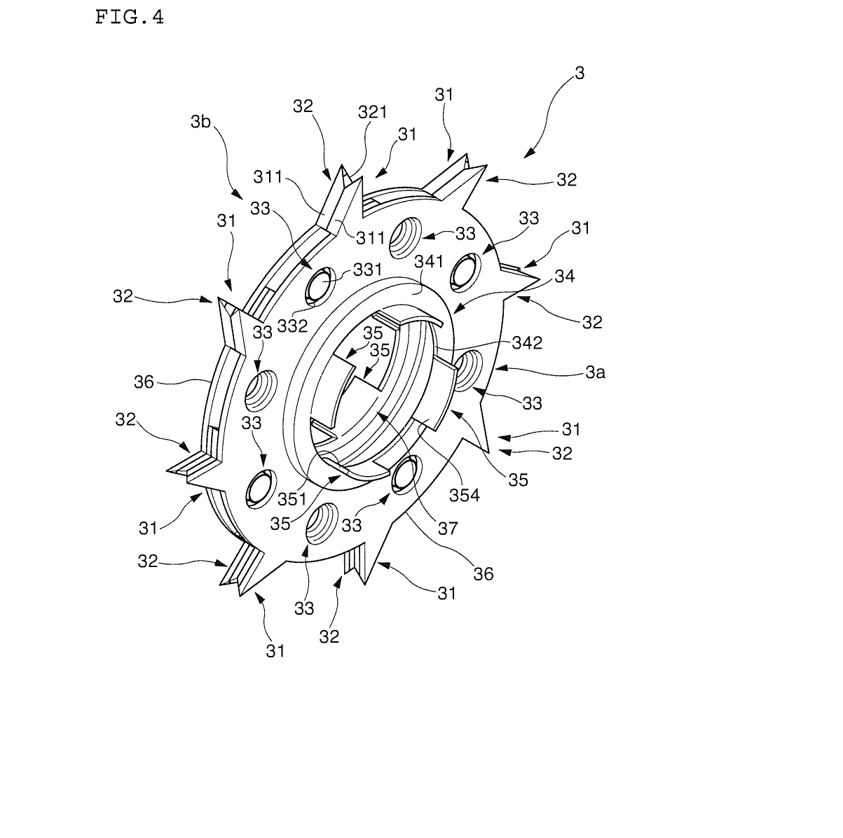

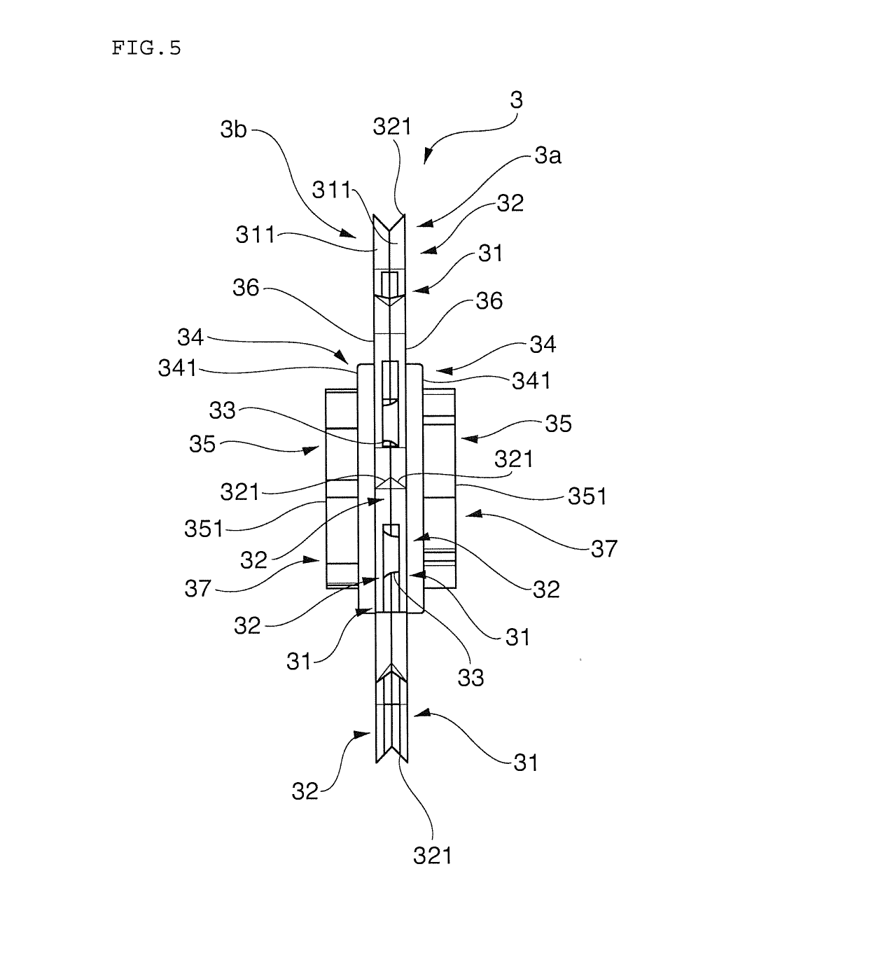

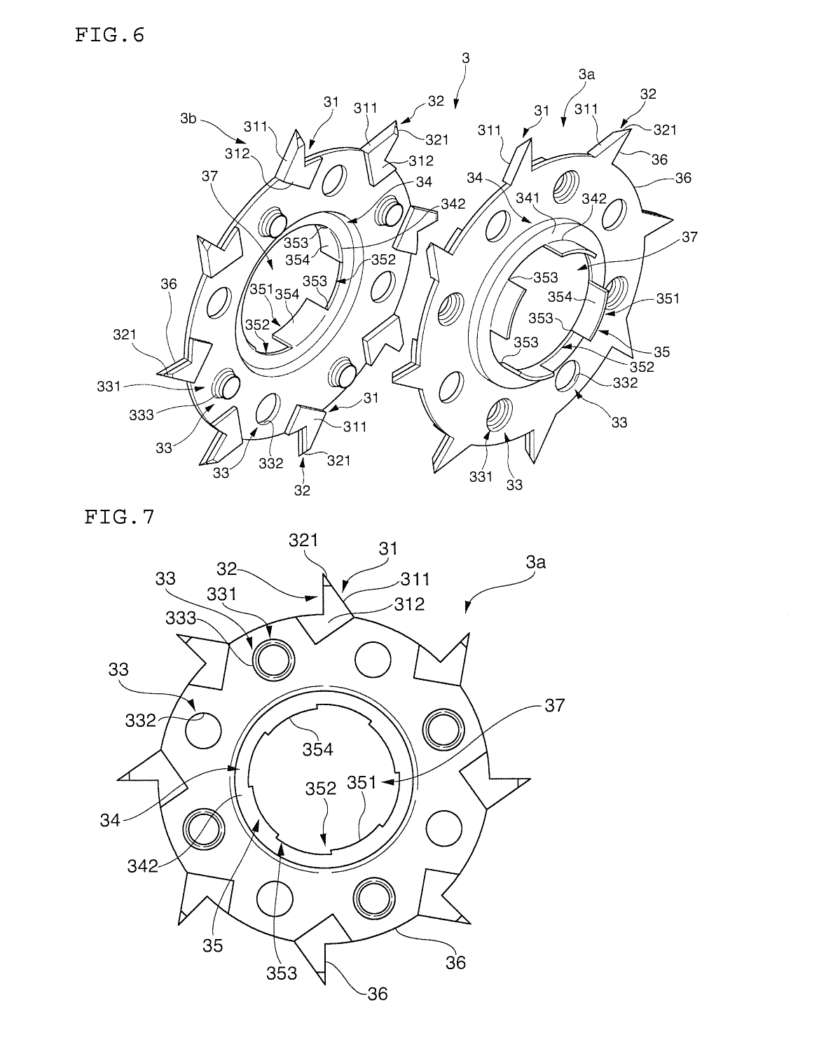

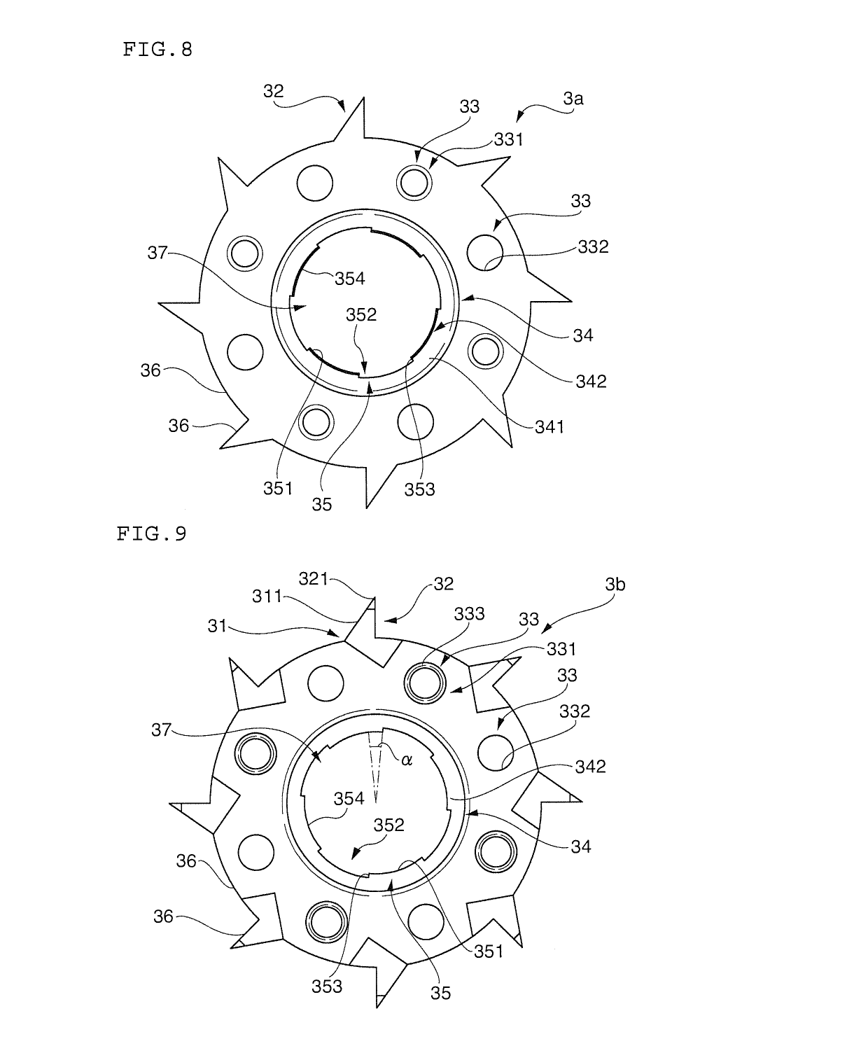

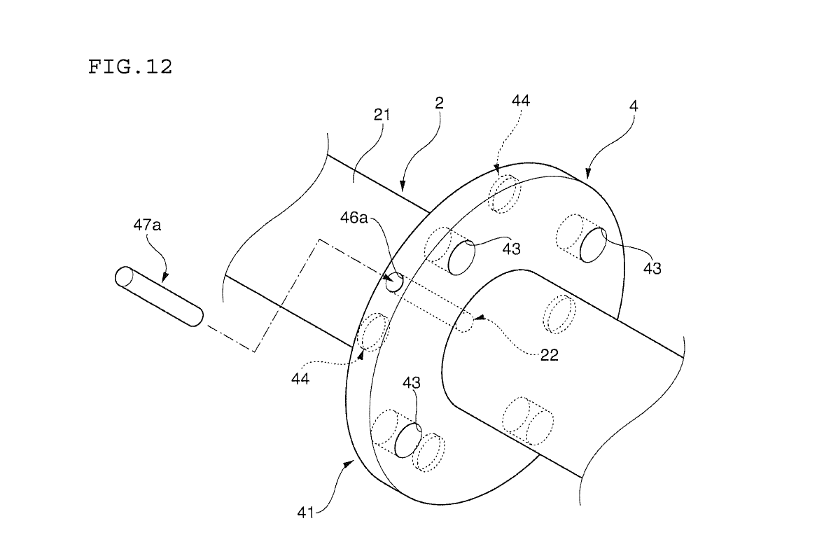

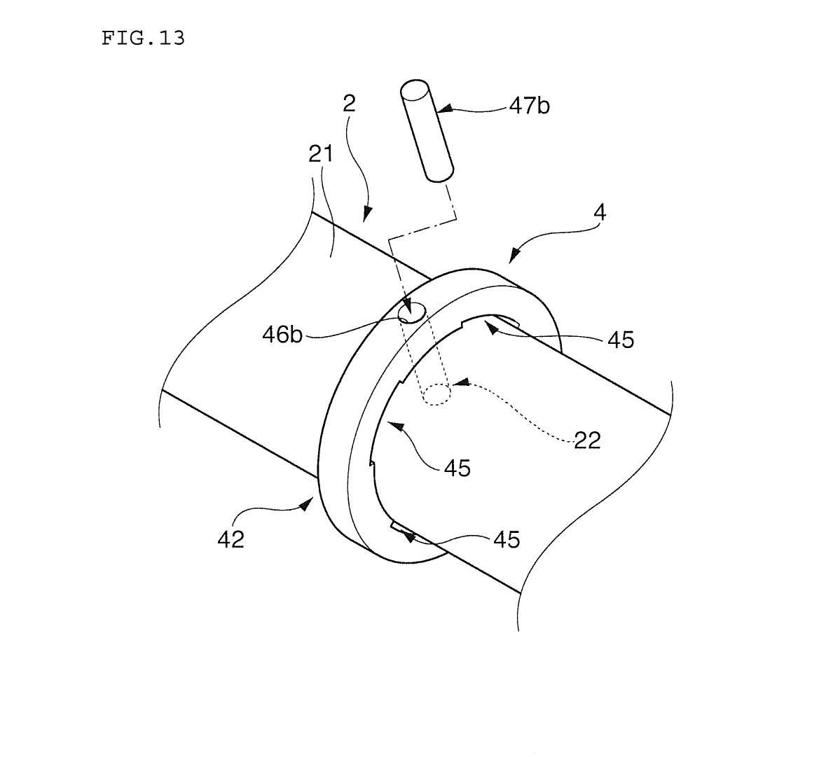

As depicted in FIGS. 2 to 15, the roller cutters 1 each have a generally cylinder-shaped rotary shaft 2 of which outer surface forms a cylindrical surface 21 and which is rotated by the drive mechanism, the finely cutting blades 3 which are successively passed on the rotary shaft 2 and supported thereby under conditions where the angular phase of each successive finely cutting blade 3 is displaced by a predetermined angle, each of the finely cutting blades 3 including disks 3a, 3b which are joined together on inside surfaces, and shaft fixation members 4 which are fixed to the rotary shaft 2 to thereby fix the finely cutting blades 3 to the rotary shaft 2 under conditions where the shaft fixation members 4 have been mounted at both ends of the finely cutting blades 3.

The roller cutters 1 according to this embodiment are characterized in that, as depicted in FIGS. 2 to 15, the finely cutting blades 3 each have folded parts 31 forming thick-walled portions which go into contact with each other, the folded parts 31 being formed by folding inward a sheet metal material used for forming the disks 3a, 3b to inwardly increase the thickness thereof.

The structure of each portion of the roller cutters 1 is described in detail hereunder.

As depicted in FIGS. 2 to 15, each finely cutting blade 3 is structured at least by fitting together the inside surfaces of the paired two disks 3a, 3b as mentioned above. Each of these disks 3a, 3b is a one-piece formed part manufactured by press of forming a generally circular piece of the sheet metal material measuring 25 to 35 mm in diameter and 0.5 to 1 mm in thickness, for example. These disks 3a, 3b each include as constituent elements of the finely cutting blade 3 the following constituent elements. Specifically, the finely cutting blade 3 includes the folded parts 31 formed by bending and folding the sheet metal material, projecting parts 32 provided for cross-cutting the object to be shredded, fitting parts 33 by which the two disks 3a, 3b are fitted together, spacer portions 34 for determining relative positions of the finely cutting blades 3 in an axial direction so as to separate facing ends of the adjacent finely cutting blades 3 from each other, engagement parts 35 for positioning the finely cutting blades 3 and engaging the same with each other, first shredding edges 36 for cutting the object to be shredded that has been inserted into strips, and a shaft hole 37 by which the finely cutting blade 3 is fitted on the rotary shaft 2. The two disks 3a, 3b have the same structure except that folding directions of the folded parts 31 and directions in which the projecting parts 32 are made opposite and relative positions where the fitting parts 33 and the engagement parts 35 are provided differ between the two disks 3a, 3b. For this reason, these constituent elements provided on the individual disks 3a, 3b are denoted by the same symbols and explained together.

A total of eight folded parts 31 are provided along an outer periphery of each of the disks 3a, 3b at equal angular intervals. The plurality of folded parts 31 thus provided are formed by performing a so-called hemming process on pieces of the sheet metal material to fold portions thereof projecting from a circular peripheral part of each of the disks 3a, 3b down to basal parts of the projecting portions. Each of the folded parts 31 has a fold-back edge 311 formed by folding the piece of the sheet metal material at a portion projecting obliquely in a radial direction from the circular part and a tight contact surface 312 which goes into contact with another one of the disks 3a, 3b which are paired on the folded inside surfaces. In this embodiment, the finely cutting blade 3 is structured such that as the tight contact surfaces 312 of the two disks 3a, 3b are brought into close contact with each other, the folded parts 31 of the finely cutting blade 3 have a thickness four times the thickness of the sheet metal material. It follows that this thickness which is four times the thickness of the sheet metal material determines the width of cutting the object to be shredded, or the width of individual shreds. While the present embodiment discloses the folded parts 31 formed by folding the sheet metal material as one form of the thick-walled portions, these folded parts 31 may be replaced by other forms of thick-walled portions. The thick-walled portion of the present invention is a concept not limited to the folded parts 31 but including various forms, such as thick-walled portions formed by attaching separate pieces of the sheet metal material by welding, for instance, or thick-walled portions formed by simply increasing the thickness of the sheet metal material in part.

The projecting parts 32 project from peripheries of the disks 3a, 3b in radial directions perpendicular to the aforementioned axial direction. In the present embodiment, the projecting parts 32 are formed by using the folded parts 31. Therefore, a total of eight projecting parts 32 are provided along the outer periphery of each of the disks 3a. 3b at equal angular intervals like the folded parts 31. In this embodiment, the plurality of projecting parts 32 are configured to individually have sharp ends, thus forming generally V-shaped second shredding edges 321. As a result of rotating motion of shredding parts, the second shredding edges 321 progressively thrust into the object to be shredded from the outside to thereby cut the object to be shredded in a direction intersecting a direction in which the object to be shredded is inserted. Incidentally, the distance between one and the adjacent edge of the plurality of the second shredding edges determines the length of shreds. Thus, the length of the individual shreds is approximately 1 cm in this embodiment. Also, the aforementioned first shredding edges 36 capable of cutting the object to be shredded in the inserting direction thereof are formed by forming sharp outer edges at portions of the projecting parts 32 that rise in radial directions. This means that the first shredding edge 36 and the second shredding edge 321 are continuously formed at each of the projecting parts 32 of the finely cutting blades 3.

The fitting parts 33 of each pair of disks 3a, 3b are for fitting together the disks 3a, 3b by a recess/protrusion fitting structure. The fitting parts 33 include four fitting protrusions 331 and fitting recesses 332 formed in each of the disks 3a, 3b at equal angular intervals. Each of the fitting protrusions 331 has a stepped stage 333 formed at a location halfway in a protruding direction to match the thickness increased by the folded part 31. Under conditions where the fitting protrusions 331 are fitted into the fitting recesses 332, the stepped stages 333 go into contact with peripheral parts of the fitting recesses 332 and are held tight against the peripheral parts thereof, whereby the thickness of each finely cutting blade 3 is maintained in a stable fashion.

Each of the spacer portions 34 is a structure formed integrally with each of the disks 3a, 3b by forming part of the disk 3a or 3b close to the center of rotation thereof to swell outward by a drawing process, for example. The spacer portions 34 each have a swell surface 341 which protrudes and goes into contact with the adjacent finely cutting blade 3 and a swell end 342 which allows the engagement parts 35 to protrude from an extreme end of the swell surface 341. Specifically, each of the spacer portions 34 is formed to swell twice the thickness of the sheet metal material, so that the distance between the first shredding edges 36 and the first shredding edges 36 of the adjacent finely cutting blade 3 just matches four times the thickness of the sheet metal material. This arrangement allows part of the disks 3a, 3b of the facing roller cutter 1 to be fitted without creating any gaps. This means that the spacer portions 34 contribute to ensuring stable operation of the finely cutting mechanism C free of jamming of the object to be shredded, such as a so-called paper jam.

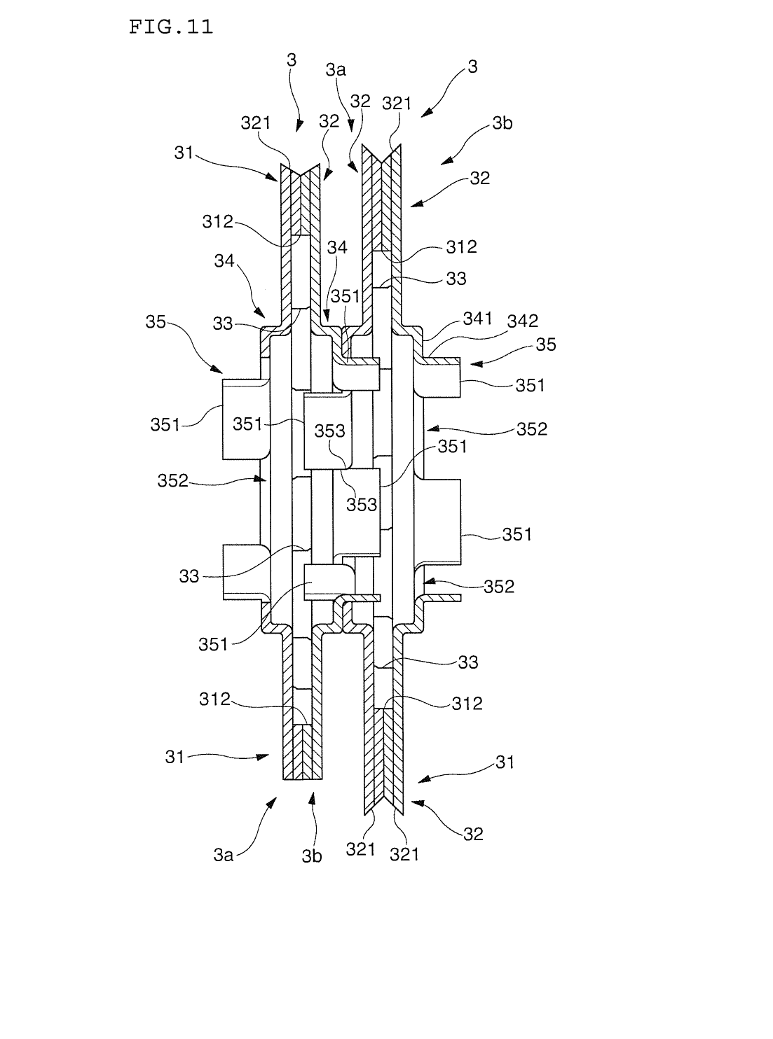

The engagement parts 35 mainly including engagement claws 351 which project further outward from the swell end 342 of the spacer portion 34 at four locations serve to determine relative positions along a rotating direction around an axis with respect to the adjacent finely cutting blade 3. Each of the engagement parts 35 includes the aforementioned engagement claws 351 which go into mutual contact with those of the adjacent finely cutting blade 3 at abutting ends 353 and claw accommodating portions 352 which can accommodate the engagement claws 351 of the adjacent finely cutting blade 3. Each of the engagement claws 351 has the aforementioned abutting end 353 and a shaft contacting surface 354 which goes into close contact with the cylindrical surface 21 which is the outer surface of the rotary shaft 2, the shaft contacting surface 354 being formed by curving the sheet metal material. In this embodiment, the width of a portion from which each of the engagement claws 351 sticks out is made generally equal to the width of the claw accommodating portion 352. As depicted in FIG. 11, points where the engagement parts 35 go into mutual contact at one working end in rotating motion constitute the abutting ends 353 in this embodiment.

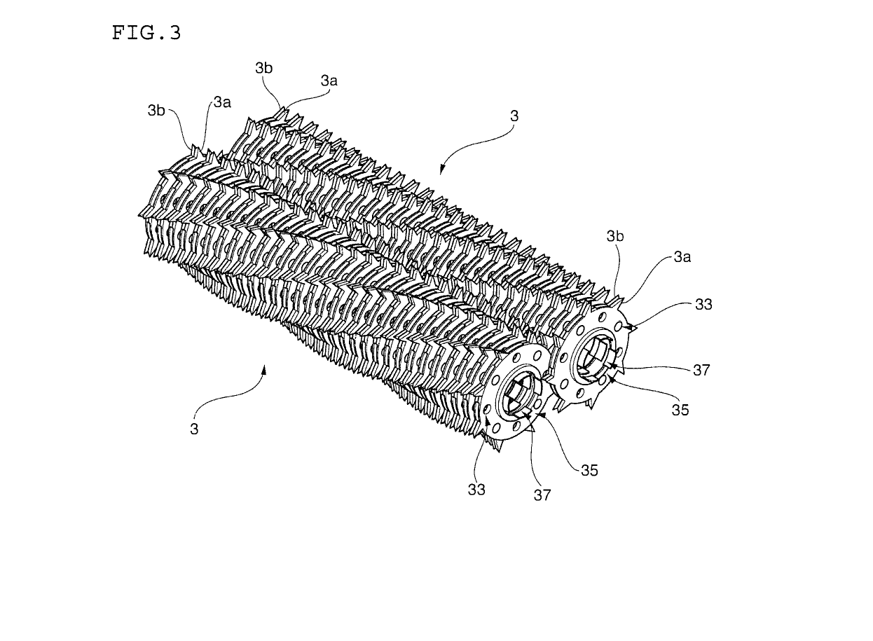

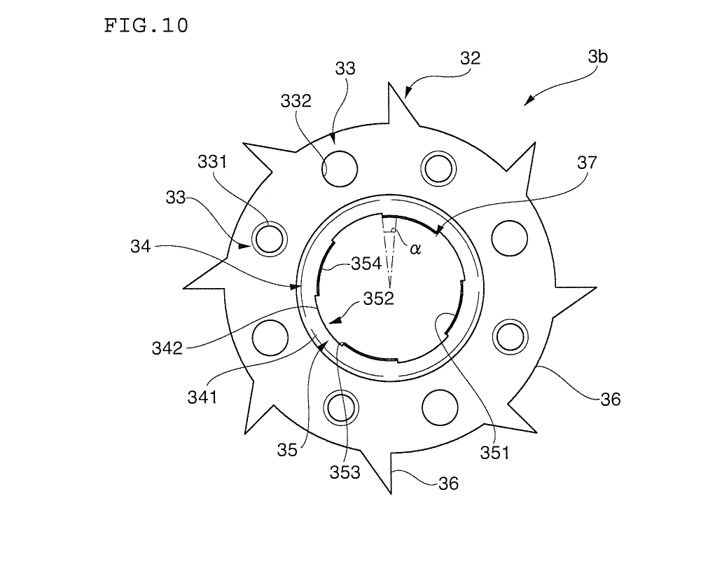

As depicted particularly in FIGS. 7 to 10, and more particularly in FIGS. 9 and 10, the engagement parts 35 of the disk 3b are displaced by a prescribed angle from those of the disk 3a in the present embodiment. Specifically, with this arrangement, the projecting parts 32 of the adjacent finely cutting blades 3 with the engagement part 35 located in between are disposed with an angular displacement of degrees respectively when the finely cutting blades 3 each including a pair of disks 3a, 3b which are joined together by means of the fitting parts 33 are assembled as depicted in FIG. 3 with the engagement parts 35 located in between.

The first shredding edges 36 which are provided at extreme ends of outer peripheries in a thickness direction of the aforementioned disks 3a, 3b slide along the finely cutting blades 3 mounted on the other rotary shaft 2 so that the first shredding edges 36 can cut the object to be shredded in the inserting direction thereof. Specifically, as the finely cutting blades 3 rotate, the first shredding edges 36 slide and contact to one another, thereby shredding the object to be shredded. The first shredding edges 36 are provided at portions of the outer peripheries of the disks 3a, 3b forming a circular shape as well as at straight portions of the projecting parts 32 that extend in the radial directions. This arrangement enables the first shredding edges 36 to continuously shred the object to be shredded in cooperation with the first shredding edges 36 of the facing roller cutter 1 while the finely cutting mechanism C is making a rotating motion.

The shaft hole 37 is an opening in which the rotary shaft 2 is fitted. In the shaft hole 37, the aforementioned shaft contacting surfaces 354 of the engagement parts 35 are in tight contact with the rotary shaft 2 with no gaps created therebetween. Thus, the finely cutting blades 3 are free from slacks with respect to the rotary shaft 2 except in the axial direction.

In this embodiment, a specific number of the above-described finely cutting blades 3 are mounted on each of the rotary shafts 2 and, under conditions where the finely cutting blades 3 are mutually positioned and the shaft fixation members 4 are engaged with the disks 3a, 3b from both axial ends, the shaft fixation members 4 are fixed to the rotary shaft 2 to thereby fix the finely cutting blades 3 to the rotary shaft 2 as depicted in FIG. 2.

Each of the rotary shafts 2 has the cylindrical surface 21 produced by forming the outer surface into a smoothly curved shape and pin fitting holes 22 formed close to both ends of the rotary shaft 2 for fixing the shaft affixation members 4. The rotary shafts 2 are each produced by simply performing an appropriate machining operation on a conventionally available metallic rod member having a cylindrical shape. Also, while the rotary shaft 2 is produced by applying an appropriate machining process so that the rotary shaft 2 is fixed to an unillustrated drive mechanism at both ends, various kinds of structures are applicable depending on the structure of the drive mechanism, for instance, with respect to specific shapes of both ends of the rotary shaft 2. For this reason, both ends of the rotary shaft 2 are not illustrated in this embodiment.

Each of the shaft affixation members 4 includes a first collar 41 which engages with the disks 3a, 3b from the inside thereof, a second collar 42 which engages with the disks 3a, 3b from the outside thereof, and roll pins 47a, 47b for fixing the first collar 41 and the second collar 42 to the rotary shaft 2. The first collar 41 is a generally doughnut-shaped element having a diameter generally equal to that of a circular periphery of the disks 3a, 3b, the first collar 41 being made of metal having high rigidity, for example. The first collar 41 has in one surface thereof mating recesses 43 and mating protrusions 44 which can mesh with the fitting parts 33 of the disks 3a, 3b, and in a peripheral surface a pin fitting hole 46a through which the roll pin 47a can be inserted all the way into the pin fitting hole 22. The second collar 42 is formed in a size generally equal to that of the aforementioned spacer portion 34 of the disks 3a, 3b, the second collar 42 also being made of metal having high rigidity. The second collar 42 has claw fixing holes 45 formed at four locations that can accommodate and fix the engagement claws 351 of the disks 3a, 3b without creating gaps and a pin fitting hole 46b formed in a peripheral surface through which the roll pin 47b can be inserted all the way into the pin fitting hole 22.

Described in the following is an example of how the finely cutting blades 3 are fixed to each of the rotary shafts 2 by using the aforementioned shaft fixation members 4 in order to assemble the roller cutters 1 of the present embodiment as illustrated in FIG. 2. For example, the second collar 42 is fixed to the rotary shaft 2 by using the roll pin 47b at first and, in this state, the disks 3a, 3b are successively mounted on the rotary shaft 2. Of course, the disks 3a, 3b assembled in advance as depicted in FIG. 3 may be mounted on the rotary shaft 2. Next, one of the first mounted disks 3a, 3b is fixed to the second collar 42 which has been fixed to the rotary shaft 2. After mounting all the finely cutting blades 3 on the rotary shaft 2 and assembling the finely cutting blades 3 together, the first collar 41 is fixed to the last mounted one of the disks 3a, 3b. Subsequently, the abutting ends 353 of all the adjacent disks 3a, 3b are brought into contact with each other by twisting the first collar 41, for example. Then, the first collar 41 is fixed by inserting the roll pin 47a in the pin fitting hole 46a, so that the finely cutting blades 3 are securely fixed to the rotary shaft 2 without any loose turning, slacks or displacement along the axial direction. Of course, the aforementioned procedure may be modified to first fix the first collar 41 to the rotary shaft 2 and lastly fix the second collar 42.

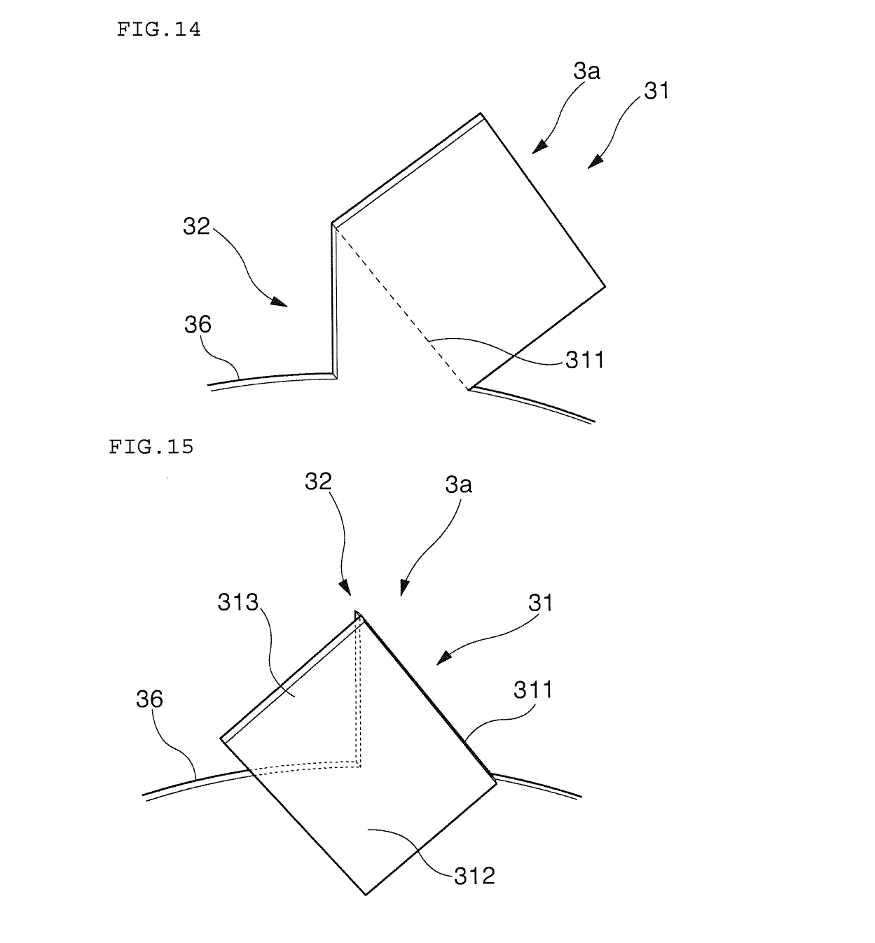

In this embodiment, the projecting parts 32 are formed by using the folded parts 31 in the below-described manner as depicted in FIGS. 14 to 17.

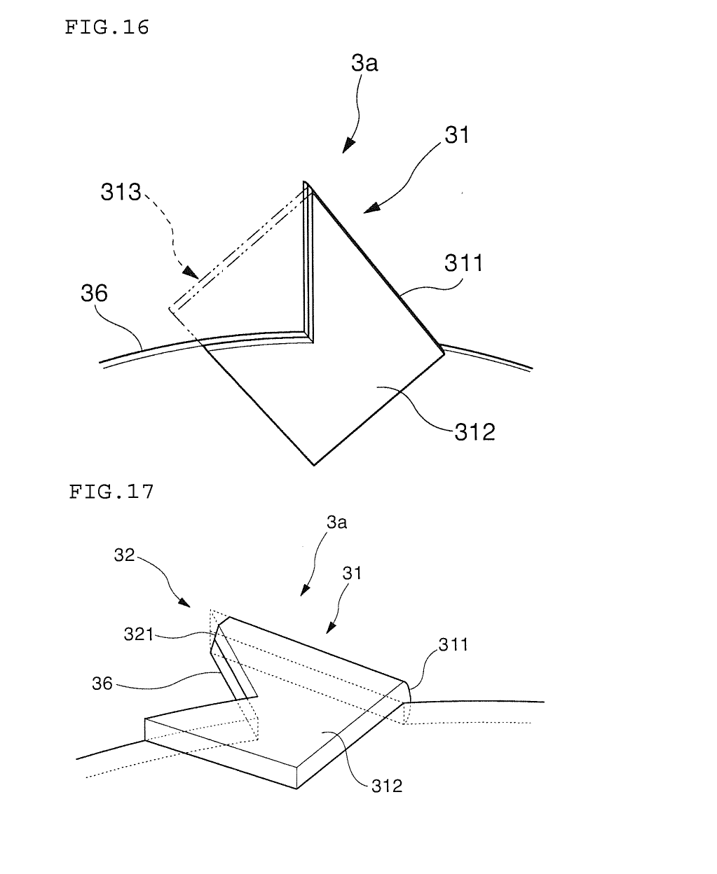

First, as depicted in FIG. 14, each of the folded parts 31 is made of a portion of the sheet metal material extended from the outer periphery of the disk 3a or 3b at a position where the projecting part 32 is formed. If this portion of the sheet metal material is folded at a location of the fold-back edge 311 indicated by a broken line in the Figure by a hemming process, for example, there is produced a state depicted in FIG. 15. In the state depicted in FIG. 15, there is created an excess portion 313 which extends beyond an area where the sheet metal material can form the projecting part 32 and the first shredding edge 36 or the second shredding edge 321, in addition to a portion which can form the folded part 31. Then, the folded part 31 is formed by cutting away the excess portion 313 as depicted in FIG. 16. Subsequently, a pointed tip of the folded part 31 is cut away or scraped off to form the second shredding edge 321 as depicted in FIG. 17.

The projecting parts 32 are formed by using portions of the sheet metal material forming the folded parts 31 as described above in this embodiment. Consequently, the projecting parts 32 are firmly formed and the second shredding edges 321 can finely cut the object to be shredded in a more reliable fashion.

In the roller cutters 1 for the shredder S according to the present embodiment structured as described above, at least one of the aforementioned paired disks 3a, 3b of each finely cutting blade 3 has the folded parts 31 forming thick-walled portions which go into contact with each other, the folded parts 31 being formed by folding inward the sheet metal material used for forming the disks 3a, 3b to inwardly increase the thickness thereof. This structure makes it possible to increase the thickness of each finely cutting blade 3 by as much as the thickness of the folded piece of the sheet metal material at the folded parts 31 while leaving other portions than the folded parts 31 at the original thickness of the sheet metal material. In this structure, the finely cutting blades 3 can be structured with a reduced amount of metallic material needed as the sheet metal material compared to the finely cutting blades 3 of a conventional structure in which dimensions of the finely cutting blades 3 are determined only by the thickness of the sheet metal material. Additionally, the structure of the embodiment provides sufficient strength because the sheet metal material is laminated at the folded parts 31.

Since the projecting parts 32 are formed by using the folded parts 31 in this embodiment, the projecting parts 32 has sufficient strength which is obtained by folding the sheet metal material. Thus, there is provided a structure in which the second shredding edges 321 can preferably shred, or cross-cut, the object to be shredded. Specifically, portions of the sheet metal material projecting from the outer peripheries of the disks 3a, 3b are folded and, subsequently, the second shredding edges 321 capable of shredding the object to be shredded along a rotating direction of the finely cutting blades 3 can be securely formed especially in the present embodiment. While the embodiment herein discloses the folded parts 31 as one form of the thick-walled portions, it is also possible to structure the projecting parts 32 having sufficient strength by using thick-walled portions formed by attaching separate pieces of the sheet metal material by welding, for instance, or thick-walled portions formed by simply increasing the thickness of the sheet metal material in part, yet ensuring that the second shredding edges 321 can perform a preferable cross-cutting operation.

The present embodiment achieves an efficient reduction in the number of components by integrally providing the finely cutting blades 3 with the spacer portions 34 which swell outward and go into contact with the adjacent finely cutting blades 3, the spacer portions 34 being formed by a drawing process, thereby avoiding the need for placing a separate collar or the like between one finely cutting blade 3 and another.

In particular, the engagement parts 35 which project outward from the spacer portions 34 and can position each finely cutting blade 3 with respect to the adjacent finely cutting blades 3 are provided in the finely cutting blade 3 itself in this embodiment. As a result, the embodiment makes it possible to employ the cylinder-shaped rotary shafts 2.

Specifically, the rotary shaft 2 is structured by just applying a simple machining operation to both ends of a cylindrical rod member, thus avoiding efficiently an arrangement for machining the surface of a shaft to produce a polygonal cross-sectional shape so that the rotary shaft 2 and the finely cutting blades 3 are engaged together or for fixing together the shaft and the individual finely cutting blades 3 as in the prior art. This makes it possible to significantly reduce the amount of work and effort needed for manufacturing the roller cutters 1 according to the present embodiment as compared to the conventional arrangement.

In order to fix the individual finely cutting blades 3 to the rotary shaft 2 in a preferable fashion using an arrangement for relatively positioning the finely cutting blades 3 by means of the engagement parts 35, the embodiment employs a structure which uses the shaft fixation members 4 for fixing the finely cutting blades 3 located at both ends along the axial direction to the rotary shaft 2 under conditions where relative positions of a plurality of finely cutting blades 3 have been determined.

Also, in order to assemble the disks 3a, 3b constituting each finely cutting blade 3 easily and securely, the present embodiment allows for secure engagement of the paired disks 3a, 3b with the provision of the fitting parts 33 for fitting together the disks 3a, 3b by a recess/protrusion fitting structure.

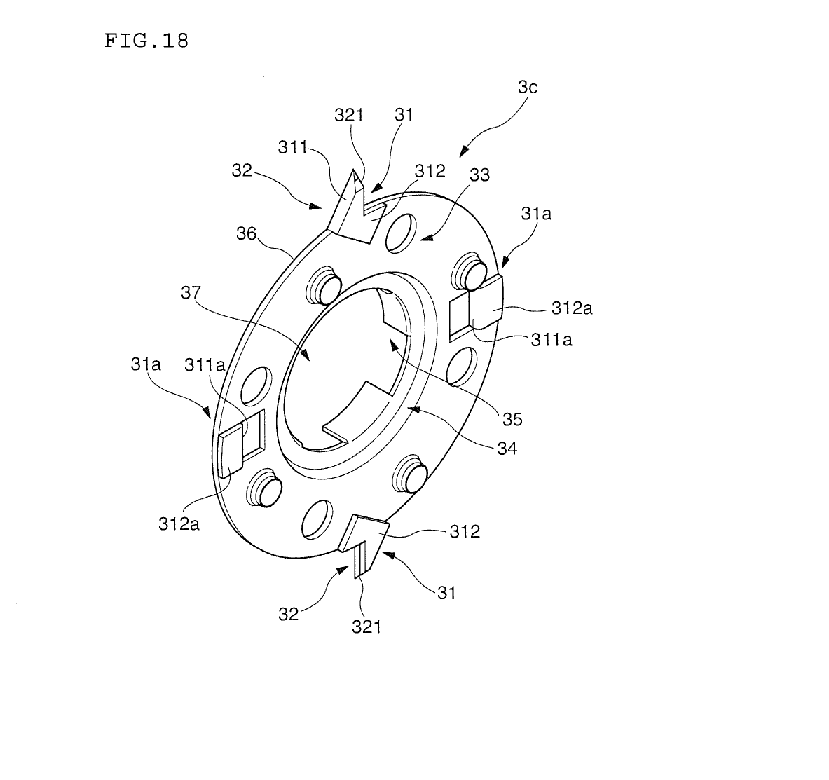

A variation of the present embodiment is described hereunder with reference to FIG. 18. In this variation, constituent elements corresponding to those of the aforementioned embodiment are designated by the same symbols and a detailed description of such elements is not given below.

While the projecting parts 32 are formed at locations of all the folded parts 31 in the foregoing embodiment, it is needless to say that the projecting parts 32 are not limited to an arrangement where the folded parts 31 are formed.

Specifically, a disk 3c constituting part of a roller cutter 1 of this variation has projecting parts 32 formed at two locations at 180-degree intervals and folded parts 31a formed by folding a piece of a sheet metal material at locations displaced by 90 degrees from the projecting parts 32, the folded parts 31a not forming the projecting parts 32. To be more specific, each portion of the sheet metal material piece cut in a U-shape surrounding a location of a fold-back edge is folded toward an outer periphery from the location a fold-back edge 311a and, then, a folded end portion is formed to match a circular shape. Since a disk paired with the disk 3c is structured such that locations of the folded parts 31, the projecting parts 32, the fitting parts 33 and the engagement parts 35 differ from those of the disk 3c as in the foregoing embodiment, this disk is not illustrated herein.

This structure makes it possible to provide the folded parts 31a at specified locations and obtain the width and strength of each of the finely cutting blades 3 even if the number of the projecting parts 32 is reduced. Also, it is needless to say that the thick-walled portions of the present invention are not limited to the structure of the folded parts 31a. Other forms of thick-walled portions of the invention which may substitute for the folded parts 31a of this variation include thick-walled portions formed by attaching separate pieces of the sheet metal material by welding, for instance, and thick-walled portions formed by simply increasing the thickness of the sheet metal material in part.

Incidentally, apart from the illustrated structure, it is also possible to structure straight-type roller cutters 1 using the present invention if only the aforementioned folded parts 31 are formed without disposing the projecting parts 32.

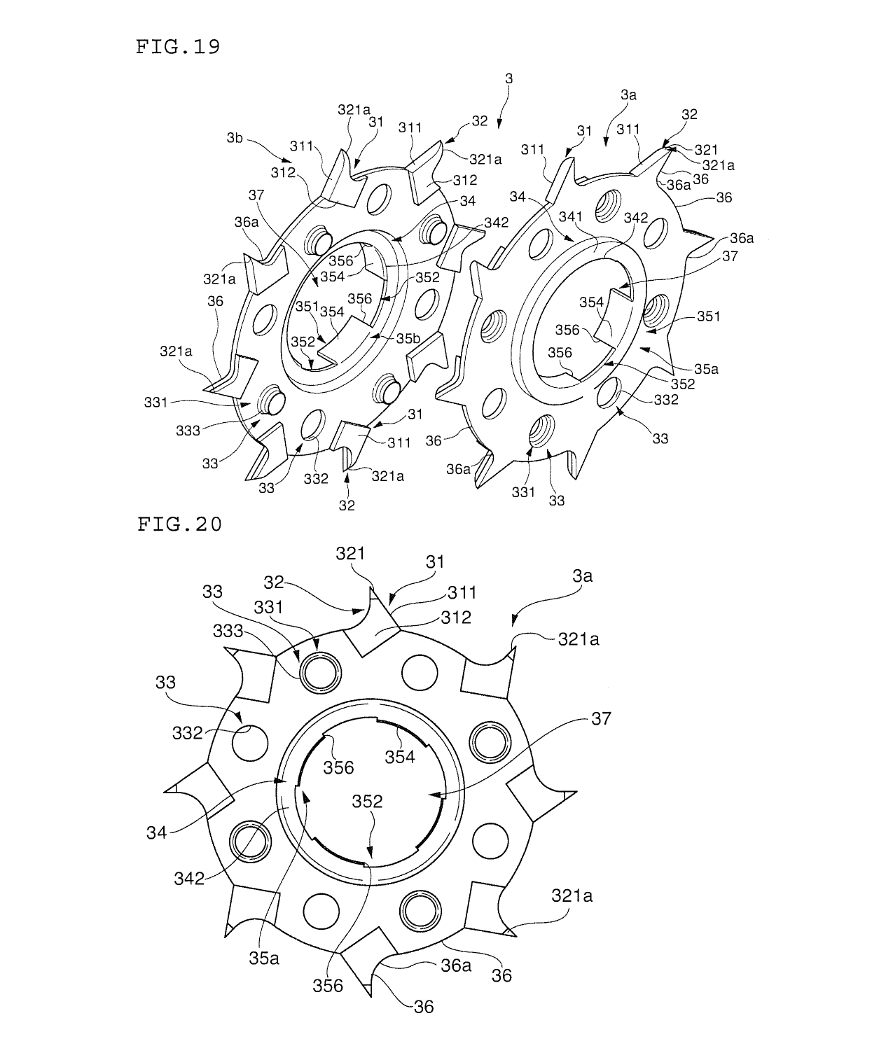

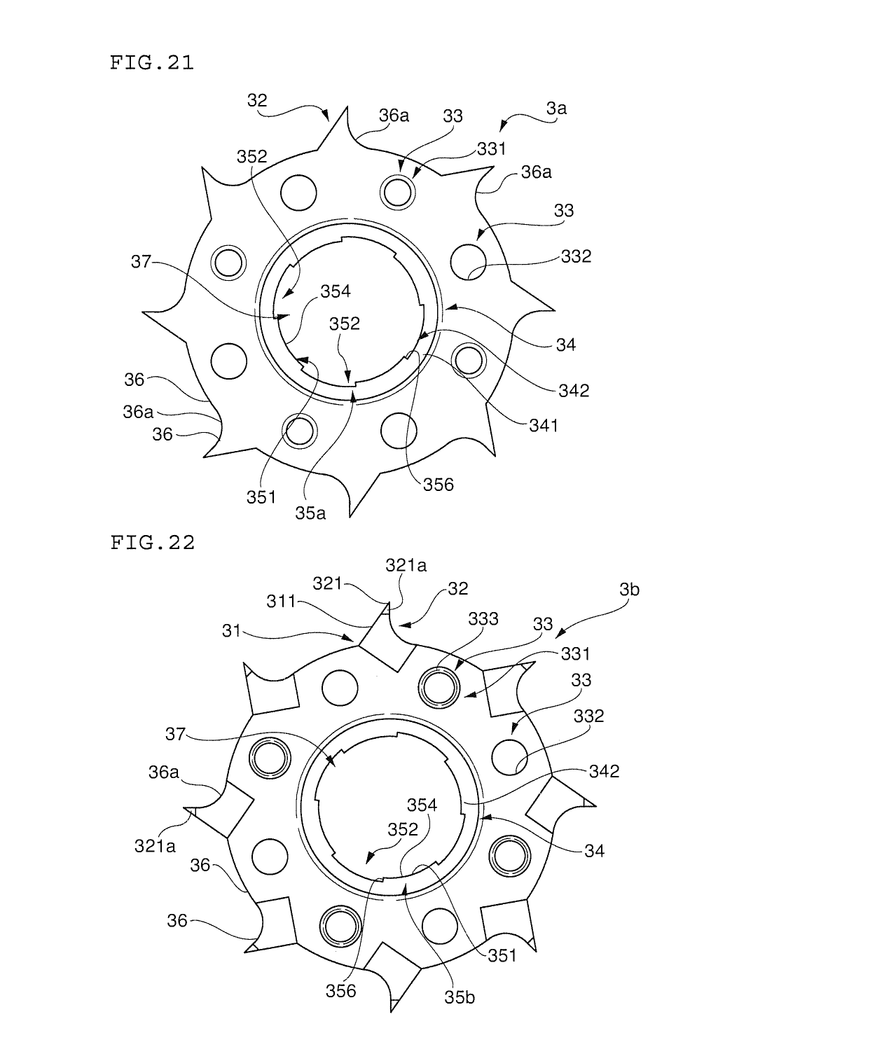

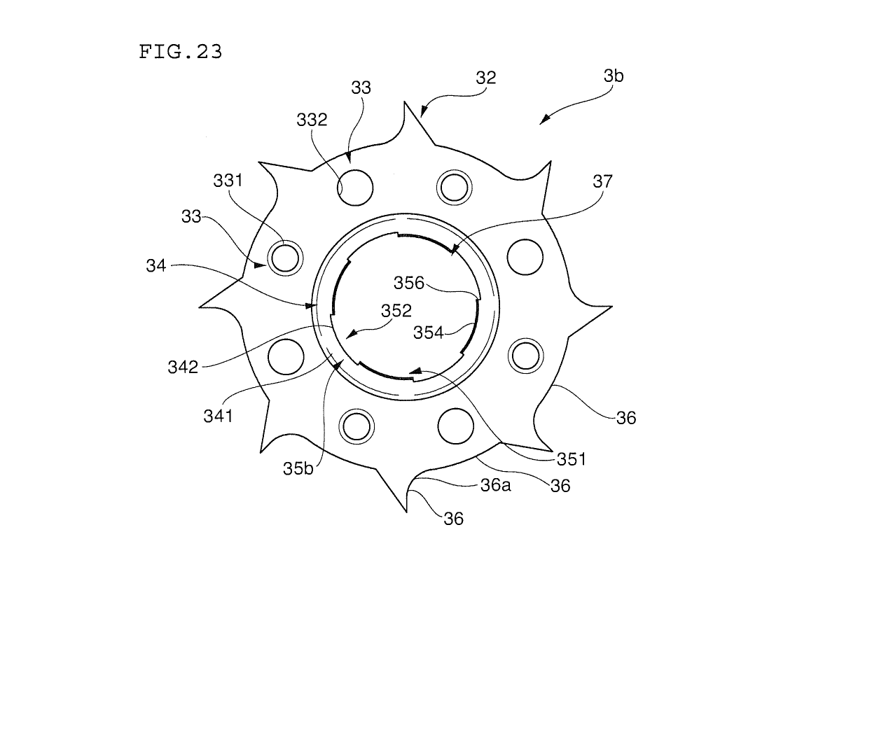

A second embodiment of the present invention is described hereunder with reference to FIGS. 19 to 26. In the second embodiment, constituent elements corresponding to those of the foregoing first embodiment are designated by the same symbols and a detailed description of such elements is not given below.

As depicted in the aforementioned Figures, each of finely cutting blades 3 is structured at least by fitting together inside surfaces of paired two disks 3a, 3b. These disks 3a, 3b each include as constituent elements of the finely cutting blade 3 the following constituent elements as in the foregoing first embodiment. Specifically, the finely cutting blade 3 includes folded parts 31, fitting parts 33, spacer portions 34 and a shaft hole 37 by which the finely cutting blade 3 itself is fitted on a rotary shaft 2. As is the case with the first embodiment, engagement parts 35 of the disk 3b are displaced by a prescribed angle from those of the disk 3a. In this embodiment, a specific number of finely cutting blades 3 are mounted on each of the rotary shafts 2 and, under conditions where the finely cutting blades 3 are mutually positioned and shaft fixation members 4 are engaged with the disks 3a, 3b from both axial ends, the shaft fixation members 4 are fixed to the rotary shaft 2 to thereby fix the finely cutting blades 3 to the rotary shaft 2 as depicted in FIG. 2 as in the foregoing embodiment.

The finely cutting blades 3 of this embodiment are configured to include projecting parts 32, engagement parts 35a, 35b and first shredding edges 36 which are shaped differently from those of the foregoing first embodiment. The structures of the projecting parts 32, the engagement parts 35a, 35b and the first shredding edges 36 are described hereinbelow.

As in the foregoing embodiment, a total of eight projecting parts 32 are provided along an outer periphery of each of the disks 3a, 3b at equal angular intervals, the projecting parts 32 being formed by using the folded parts 31. In this embodiment, the plurality of projecting parts 32 are configured to individually have sharp ends, also forming second shredding edges 321 having swelling ends 321a which stick out while swelling outward from the inside of each of the disks 3a, 3b. As a result of rotating motion of shredding parts, the second shredding edges 321 successively thrust into an object to be shredded from the outside to thereby cut the object to be shredded in a direction intersecting a direction in which the object to be shredded is inserted. Also, the aforementioned first shredding edges 36 capable of cutting the object to be shredded in the inserting direction thereof are formed by forming sharp outer edges at portions of the projecting parts 32 that rise in radial directions while curving. As will be described later, the first shredding edges 36 each have a curved portion 36a that extend outward from the outer periphery in a continuously curved shape.

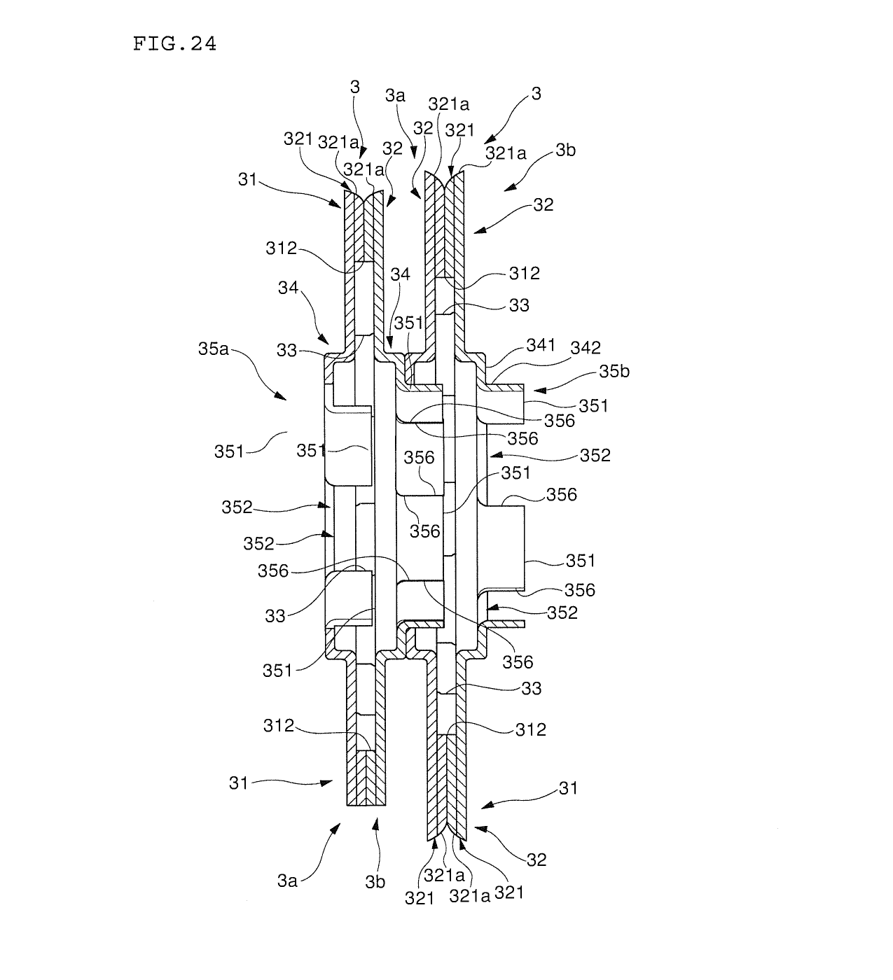

The engagement parts 35a, 35b mainly include engagement claws 351 which project further outward from the swell end 342 of the spacer portion 34 at four locations. The engagement part 35b of one of the paired two disks, or the disk 3b, is configured to project outward and the engagement part 35a of the other disk 3a is configured to project inward in order to position each finely cutting blade 3 relative to the adjacent finely cutting blade 3. Each of the engagement parts 35 includes the engagement claws 351 which go into mutual contact with those of the adjacent finely cutting blade 3 and claw accommodating portions 352 which can accommodate the engagement claws 351 of the adjacent finely cutting blade 3. Each of the engagement claws 351 has a shaft contacting surface 354 which goes into close contact with the cylindrical surface 21 which is the outer surface of the rotary shaft 2. In this embodiment, the width of a portion from which each of the engagement claws 351 sticks out is made generally equal to the width of the claw accommodating portion 352. As depicted in FIG. 24, the engagement claws 351 of this embodiment are configured such that end surfaces of the engagement claws 351 form tight contact surfaces 356 which go into tight contact with each other generally over entire surface areas with the engagement parts 35a projecting inward.

The first shredding edges 36 can cut the object to be shredded in the inserting direction thereof by sliding and contacting to the finely cutting blades 3 mounted on rotary shaft 2. The object to be shredded is shredded as a result of mutual sliding action of the first shredding edges 36. In this embodiment, the first shredding edges 36 are provided at portions of the outer peripheries of the disks 3a, 3b forming a circular shape as well as at straight portions of the projecting parts 32 that stick out in the radial directions with curved sections extending from the outer periphery in the continuously curved shape located therebetween. The curved sections mentioned above constitute the aforementioned curved portions 36a. According to this arrangement, the circular outer peripheral portions and the straight portions occur uninterruptedly during a process in which the first shredding edges 36 continuously shred the object to be shredded in cooperation with the first shredding edges 36 of the facing roller cutter 1 while the finely cutting mechanism C is making a rotating motion. This serves to avoid the occurrence of a situation in which shreds are excessively bent in part or permanently folded.

The finely cutting blades of the present embodiment are configured such that the tight contact surfaces 356 of the engagement claws 351 go into tight contact with each other generally over the entire areas of the end surfaces when the finely cutting blades 3 are joined together by means of the engagement parts 35a, 35b as depicted in FIG. 24. This allows the finely cutting blades 3 to be securely positioned each other in a stable fashion.

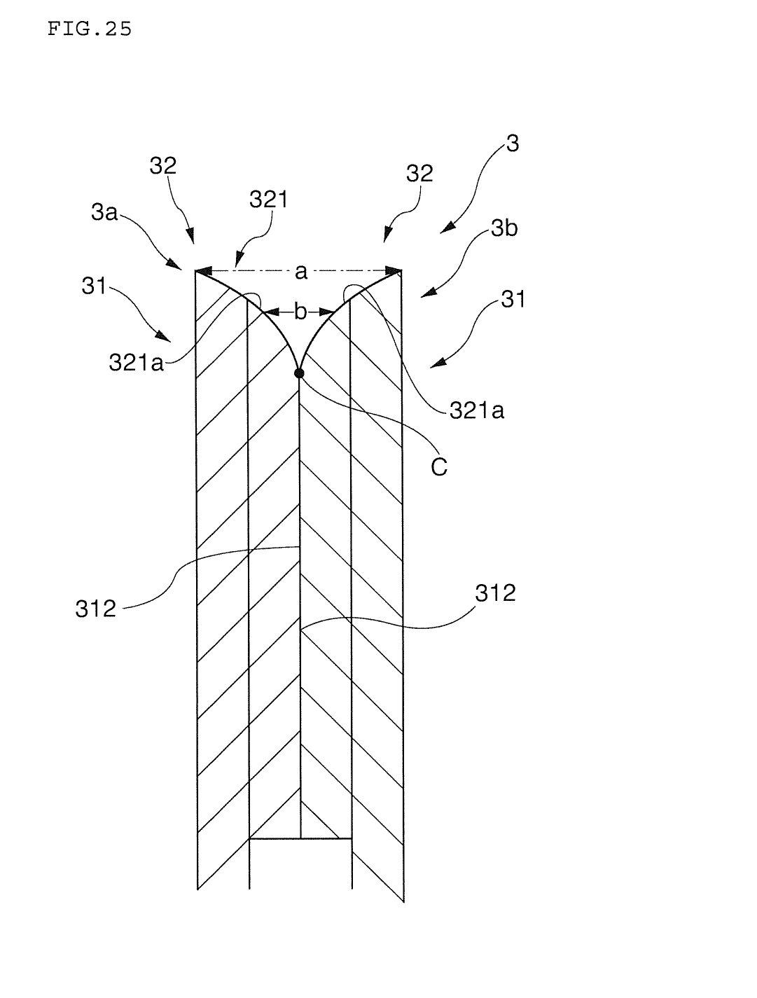

Also, the swelling ends 321a are formed on the second shredding edges 321 of the projecting parts 32 as depicted in FIG. 25 in this embodiment and, therefore, when the second shredding edges 321 progressively thrust into the object to be shredded like a sheet of paper from a point where extreme ends of the second shredding edges 321 are separated by distance “a”, the object to be shredded can reach a point where the second shredding edges 321 are separated by distance “b” in an early stage, wherein the object to be shredded has been almost shredded. In this structure, the object to be shredded is easily cut into separate shreds prior to a point where the object to be shredded reaches boundaries c of the tight contact surfaces 312. It follows that this structure effectively excludes the possibility that the object to be shredded which could not been completely shredded jams between the disks 3a, 3b.

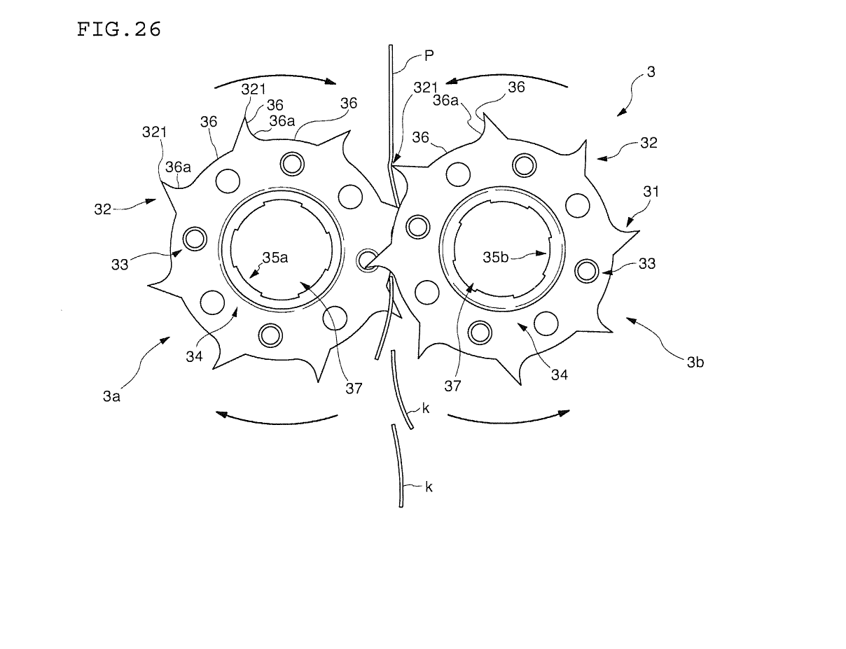

As depicted in FIG. 26 indicating the finely cutting blades 3 located against each other, a sheet of paper P is bent and cut along the shape of the first shredding edges 36 when the illustrated sheet of paper P is passed between these finely cutting blades 3 as a result of rotation thereof and shredded along a direction in which the sheet of paper P is passed in the present embodiment. As illustrated in the Figure, the curved portions 36a are located between the first shredding edges 36 on a circular periphery of the disks 3a, 3b and the first shredding edges 36 formed on the projecting parts 32 in this embodiment. This serves to avoid the occurrence of a situation in which the sheet of paper P is sharply bent locally. Consequently, shreds k cut by the second shredding edges 321 drop without being severely bent along a longitudinal direction. Although not illustrated, even if the shreds k are entrained sideways as illustrated as a result of rotation of the finely cutting blades 3, the shreds k can easily be removed by a scraper provided between the finely cutting blades 3 in this embodiment.

As mentioned in the foregoing, the second embodiment of the present invention provides, in addition to advantages of the first embodiment, a capability to effectively avoid formation of permanent bends in the shreds k as illustrated in FIG. 26 because the first shredding edges 36 have the curved portions 36a. The shreds k produced without being severely bent as discussed above provide a feature that the shreds k do not become excessively bulky in the waste bin of the shredder but also effectively prevent a problem that the shreds k become entangled around the rotating finely cutting blades 3 and adhere thereto.

Additionally, since the swelling ends 321a used when the second shredding edges 321 shred the object to be shredded are formed, a gap between basal parts where the second shredding edges 321 extend further outward from the tight contact surfaces 312 constituting a joint between the two disks 3a, 3b is made narrow. This serves to effectively prevent a problem that the object to be shredded becomes bitten between the disks 3a, 3b through the tight contact surfaces 312.

Especially in the present embodiment, directions in which the engagement claws 351 of the engagement parts 35a, 35b of the respective disks 3a, 3b project are made different from each other, one inward and the other outward, so that the tight contact surfaces 356 can go into tight contact with each other over broad surface areas along the projecting direction. Accordingly, the embodiment provides a structure which can realize secure and high-precision positioning, making it possible to effectively increase durability of the finely cutting blades 3 themselves.

While the embodiments of the present invention have thus far been described, specific structures of the individual elements are not simply limited to the foregoing embodiments but may be modified in various ways without departing from the scope and spirit of this invention.

For example, while the foregoing embodiments have disclosed arrangements in which the object to be shredded is shredded only at a location where the roller cutters are provided, there may be disposed a special element for further cutting a beltlike object to be shredded along a longitudinal direction thereof. Furthermore, specific features, such as the thickness of the sheet metal material and the length of each shaft, are not limited to what has been described in the foregoing embodiments but various arrangements including conventionally available ones may be employed.

The specific structures of the individual elements are not otherwise limited to those of the foregoing embodiments but may be modified in various ways without departing from the scope and spirit of this invention.

### INDUSTRIAL APPLICABILITY

The present invention is applicable to a shredder capable of shredding sheets of paper, or the like, and to roller cutters for a shredder that are used in the shredder.

### Description of the Symbols

2. Rotary shafts

3a, 3b. Disks

3. Finely cutting blades

31. Thick-walled portions (folded parts)

32. Projecting parts

321. Shredding edges (second shredding edges)

321a. Swelling ends

33. Fitting parts

34. Spacer portions

342. Swell ends

35, 35a, 35b. Engagement parts

353. Working end (abutting ends)

356. Tight contact surfaces

36. Shredding edges (first shredding edges)

36a. Curved portions

37. Shaft hole

4. Shaft fixation members

While the invention has been particularly shown and described with reference to a preferred embodiment thereof, it will be understood by those skilled in the art that various other changes in the form and details may be made without departing from the spirit and scope of the invention.

A presently preferred embodiment of the present invention and many of its improvements have been described with a degree of particularity. It should be understood that this description has been made by way of example, and that the invention is defined by the scope of the following claims.

1. A roller cutter for a shredder comprising a plurality of finely cutting blades arranged along an axial direction, each of said finely cutting blades being configured with at least a pair of disks which are assembled together, wherein each of said finely cutting blades has at least on one of said paired disks a thick-walled portion which is formed by inwardly increasing the thickness of a piece of a sheet metal material constituting said disk that is in contact with said other disk.

2. The roller cutter for the shredder according to claim 1, wherein a projecting part which projects from an outer periphery of said disk in a radial direction perpendicular to the axial direction is formed by using said thick-walled portion.

3. The roller cutter for the shredder according to claim 2, wherein said projecting part is formed by folding part of said sheet metal material projecting from said outer periphery of said disk and, wherein a shredding edge is formed capable of shredding an object to be shredded along a rotating direction of said finely cutting blade.

4. The roller cutter for the shredder according to claim 3, wherein said projecting part has a first shredding edge for cutting the object to be shredded along a direction in which the object is inserted and a second shredding edge for cutting the object to be shredded along a direction intersecting the inserting direction of the object to be shredded.

5. The roller cutter for the shredder according to claim 4, wherein said first shredding edge comprises a curved portion that extends outward from said outer periphery in a continuously curved shape.

6. The roller cutter for the shredder according to claim 4, wherein said second shredding edge comprises a swelling end that sticks out while swelling outward from the inside of said disk.

7. The roller cutter for the shredder according to claim 1, wherein each of said finely cutting blades has a spacer portion that protrudes outward and contacts the adjacent one of said finely cutting blades.

8. The roller cutter for the shredder according to claim 7, wherein said roller cutter is provided with an engagement part that projects further outward from a swell end of said spacer portion and can determine relative positions along the rotating direction around an axis with respect to the adjacent finely cutting blade.

9. The roller cutter for the shredder according to claim 1, wherein each of said finely cutting blades comprises an engagement part that projects outward and can determine relative positions along the rotating direction around an axis with respect to the adjacent finely cutting blade.

10. The roller cutter for the shredder according to claim 1, wherein each of said finely cutting blades comprises engagement parts that can determine relative positions along the rotating direction around an axis with respect to the other finely cutting blade, and wherein the engagement part of one of said paired disks projects outward while the engagement part of the other of said paired disks projects inward, and an end of each of the engagement parts constitutes a contact surface that can go contact an end of the engagement part of the adjacent finely cutting blade along the projecting direction thereof.

11. The roller cutter for the shredder according to claim 1, further comprising a cylindrical rotary shaft for supporting said plurality of finely cutting blades, wherein each of said finely cutting blades comprises a shaft hole in which said rotary shaft is fitted.

12. The roller cutter for the shredder according to claim 11, further comprising shaft affixation members for affixing said finely cutting blades located at both ends along the axial direction to said rotary shaft under conditions wherein relative positions of said plurality of finely cutting blades have been determined.

13. The roller cutter for the shredder according to claim 1, wherein each of said finely cutting blades comprises a fitting part for fitting together said paired disks by a recess/protrusion fitting structure.

14. A shredder comprising at least a pair of roller cutters according to claim 1, said pair of roller cutters being located to partially overlap each other.
